(19) United States
(12) Patent Application Publication
(10) Pub. No.: US 2024/0363011 A1
(43) Pub. Date: Oct. 31, 2024

(54) METHOD FOR CONSTRUCTING AND AUTOMATICALLY CONTROLLING A SPEED PROFILE COMPRISING AT OR AT OR ABOVE SPEED RESTRICTIONS

(71) Applicant: THALES, MEUDON (FR)

(72) Inventors: Michel ROGER, TOULOUSE (FR); Pascal RIVES, TOULOUSE (FR); Jérôme SACLE, TOULOUSE (FR); Guy DEKER, TOULOUSE (FR)

(21) Appl. No.: 18/578,668

(22) PCT Filed: Jul. 22, 2022
(86) PCT No.: PCT/EP2022/070709

§ 371 Date: Jan. 11, 2024

(30) Foreign Application Priority Data
Jul. 23, 2021 (FR) FR2107986

(51) Int. Cl. G08G 5/00

(52) U.S. Cl. CPC G08G 5/0039; G08G 5/0017

(57) ABSTRACT

A method for managing speed constraints of a flight plan of an aircraft, the method includes the following steps: identifying a current flight phase, determining CAS speed profile, the speed profile establishing a behavior of the aircraft with respect to a speed setpoint, determining a Mach speed profile, the Mach speed profile establishing a behavior of the aircraft with respect to a Mach setpoint, the Mach setpoint being a speed setpoint transcribed into an equivalent Mach number, determining a Cross-Over altitude, the Cross-Over altitude being an altitude of transition from an automatic control of the aircraft according to the CAS speed profile to an automatic control according to the Mach speed profile, determining an end-of-applicability criterion of the speed profile and of the Mach speed profile.

### CROSS-REFERENCE TO RELATED APPLICATIONS

This application is a National Stage of International patent application PCT/EP2022/070709, filed on Jul. 22, 2022, which claims priority to foreign French patent application No. FR 2107986, filed on Jul. 23, 2021, the disclosures of which are incorporated by reference in their entireties.

### FIELD OF THE INVENTION

The invention relates to the field of aeronautical navigation and the management of aircraft paths. And, more particularly, the invention deals with the construction of a complete flight profile, that is to say from take-off to landing, comprising a speed profile for the flight of an aircraft, the operation of this profile as well as the means making it possible to facilitate the operation of this profile by an operator once the aircraft is in flight. A flight plan is a physical or digital document describing the planned flight of an aircraft from its take-off to its landing and communicated to the air traffic services. This document contains the route envisaged and the technical characteristics, such as the altitude, the speed, or even the distance, necessary for the good progress of the flight of the aircraft. A speed profile is the result of a calculation comprising the speed characteristics and making it possible to automatically control the aircraft in terms of speed during the different phases which make up the flight.

### BACKGROUND

Generally, each component of an aircraft is subject to standards imposing upon it particular constraints ensuring overall good operation and therefore the viability of the aircraft. The Flight Management System (FMS) is, for example, subject to specific standards (TSOC-115 for the navigability, DO283 for the RNP functions, ARINC 702A for the FMS functions, ARINC 424 for the navigation database containing all the procedures, et cetera) requiring it to be capable of managing all types of constraints governing the departure and the arrival of an aircraft originating from or going to any airport. Some of these constraints are speed constraints. Among these constraints, some, made mandatory by the new DO283B standard, impose on the aircraft a target AT speed or a minimum AT OR ABOVE speed to be observed at a given point of the flight plan.

Currently, no known flight management system FMS implements the display and management of this new type of speed constraint, which results in a manual management of the situation by the operator.

Thus, during the complete flight, it may be planned for the aircraft to have to observe these particular speed constraints at any given waypoint, in a climbing phase CLIMB, in cruising flight CRUISE, in a descent phase DESCENT or in a landing approach phase APPROACH, constraints that are defined in a published procedure or that are imposed for example by an air traffic controller. Now, as stated previously, it is not technically possible in the state-of-the-art to automatically insert such a speed constraint into a normal speed profile determined in the above-mentioned manner.

As presented previously, no known flight management system FMS is currently able to manage the AT OR ABOVE speed constraints. Indeed, only the AT OR BELOW constraints or the AT constraints are so managed (the AT constraints being considered in the same way as the AT OR BELOW constraints). Furthermore, the document FR3014213 presents an issue of management of the AT or AT OR ABOVE speed constraints. Nevertheless, this document proposes taking into consideration the AT or AT OR ABOVE speed constraints only in the DESCENT and APPROACH phases, representing the flight phase during which the altitude of the aircraft decreases so as to reach the final landing phase. Now, these constraints can also exist in other flight phases. A solution should therefore be proposed that makes it possible to calculate a complete and coherent flight profile over all of the flight phases. Furthermore, the document FR3014213 requires the calculation of a starting point of an acceleration to a speed constraint in a backward calculation process. The calculation of this type of point is complex in development, and therefore presents risks of rework, requires a greater maturation time, and is costly in terms of response time performance levels.

### SUMMARY OF THE INVENTION

The invention aims to mitigate all or part of the problems cited above by proposing a method for managing, calculating and automatically controlling a complete speed profile, for the CLIMB, CRUISE, DESCENT and APPROACH flight phases, taking into account the AT and AT OR ABOVE speed constraint types.

In addition, the method proposes defining speed setpoints allowing the airplane to automatically follow this speed profile, facilitating the operation thereof by a pilot.

To this end, the subject of the invention is a method for managing speed constraints of a flight plan of an aircraft, the method comprising the following steps:
Identifying a current flight phase,
Determining a CAS speed profile, the speed profile establishing a behavior of the aircraft with respect to a speed setpoint,
Determining a Mach speed profile, the Mach speed profile establishing a behavior of the aircraft with respect to a Mach setpoint, the Mach setpoint being a speed setpoint transcribed into an equivalent Mach number,
Determining a Cross-Over altitude, the Cross-Over altitude being an altitude of transition from an automatic control of the aircraft according to the CAS speed profile to an automatic control according to the Mach speed profile,
Determining an end-of-applicability criterion of the speed profile and of the Mach speed profile.

According to one aspect of the invention, the step of determining the CAS speed profile comprises a step of constructing a first CAS speed profile, the speed setpoint according to the first CAS speed profile being constructed on the basis of aircraft performance levels.

According to one aspect of the invention, the step of determining the CAS speed profile comprises a step of constructing a second CAS speed profile, the speed setpoint according to the second speed profile allowing the aircraft to observe all of the speed constraints in the flight phase.

According to one aspect of the invention, the step of determining the speed profile comprises a step of constructing a third CAS speed profile, the speed setpoint according to the third speed profile being constructed in the knowledge of a predefined target speed of the aircraft and a predefined speed constraint.

According to one aspect of the invention, the step of determining the Mach speed profile comprises a step of constructing a first Mach speed profile, the Mach setpoint according to the first Mach speed profile being determined as a function of a predefined Mach.

According to one aspect of the invention, the step of determining the Mach speed profile comprises a step of constructing a second Mach speed profile, the Mach setpoint according to the second Mach speed profile allowing the aircraft to observe all of the speed constraints in the flight phase.

According to one aspect of the invention, the step of determining a Cross-Over altitude comprises a step of calculating a first Cross-Over altitude, the first Cross-Over altitude being calculated as a function of a predefined first CAS speed constraint, a previously defined CAS speed and a previously defined Mach.

According to one aspect of the invention, the step of determining a Cross-Over altitude comprises a step of calculating a second Cross-Over altitude, the second Cross-Over altitude being a function of a second predefined CAS speed constraint, of an imposed flight level and of a previously defined Mach.

According to one aspect of the invention, the step of determining a Cross-Over altitude comprises a step of calculating a chosen Cross-Over altitude, the chosen Cross-Over altitude being the altitude that allows the aircraft to observe the CAS speed setpoint.

According to one aspect of the invention, the end-of-applicability criterion is an end of the flight phase or having reached a predefined altitude.

According to one aspect of the invention, the method for managing speed constraints comprises a step of elimination of a speed constraint following the step of determining the end-of-applicability criterion.

According to one aspect of the invention, the method for managing speed constraints comprises a step of maintaining an imposed speed of the flight phase.

According to one aspect of the invention, the method for managing speed constraints comprises a step of monitoring the speed constraints.

According to one aspect of the invention, the method for managing speed constraints comprises an additional step of adjusting the speed of the aircraft with respect to a first speed constraint of the next flight phase.

According to one aspect of the invention, the method for managing speed constraints comprises a step of displaying speed constraints during the flight phase.

The invention also deals with a computer program product, said computer program comprising code instructions making it possible to perform the steps of the method when said program is run on a computer.

### BRIEF DESCRIPTION OF THE DRAWINGS

The invention will be better understood, and other advantages will become apparent, on reading the detailed description of an embodiment given by way of example, the description being illustrated by the attached drawing in which:

FIG. 1 represents a method for managing speed constraints of a flight plan of an aircraft according to the invention;

FIG. 2 represents a step of determining a speed profile of the method for managing speed constraints of a flight plan of an aircraft according to a first embodiment;

FIG. 3 is a schematic representation of a speed profile resulting from the management of speed constraints of a flight plan according to the first embodiment;

FIG. 4 represents the step of determining a flight plan of the method for managing speed constraints of a flight plan of an aircraft according to a second embodiment and a third embodiment;

FIG. 5 represents a step of determining a strategy and a step of determining a Cross-Over altitude of the method for managing speed constraints of a flight plan of an aircraft;

FIG. 6 represents additional steps of the method for managing speed constraints of a flight plan of an aircraft.

For clarity, the same elements will bear the same references in the various figures.

### DETAILED DESCRIPTION

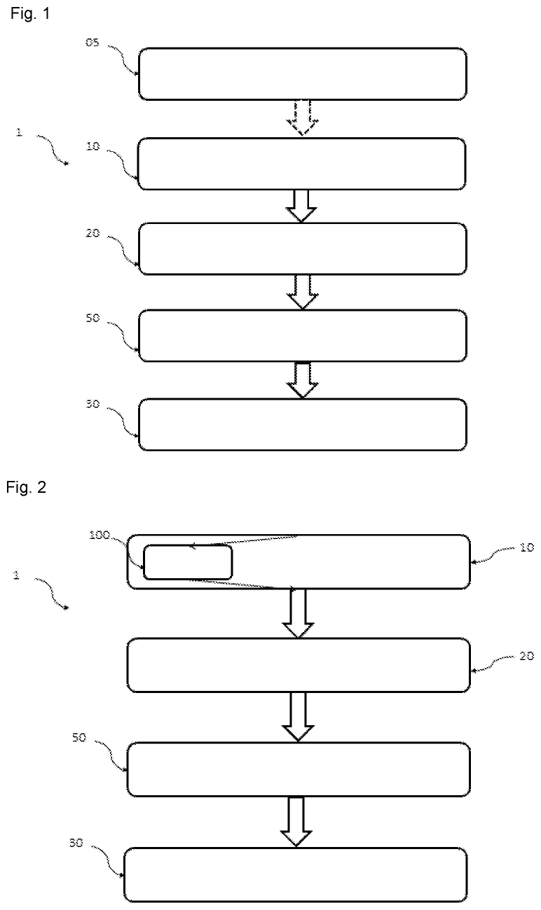

The invention presents a method 1, represented in FIG. 1, for managing speed constraints of a flight plan of an aircraft that is capable of proposing a complete flight profile that can be applied to the CLIMB, CRUISE, DESCENT and APPROACH flight phases. The management method 1 according to the invention aims to propose a complete profile to allow the aircraft to fly it automatically and autonomously, and to facilitate the operation of this complete profile by an operator once in flight. The management method 1 is implemented for speed constraints of AT type, representing a speed to be observed, of AT OR BELOW type representing a maximum speed to be observed or of AT OR ABOVE type representing a minimum speed to be observed. The management method 1 also makes it possible to take into consideration a constraint of WINDOW type representing a speed window between a minimum speed and a maximum speed as a combination of an AT OR BELOW speed constraint and of an AT OR ABOVE speed constraint.

The method 1 for managing speed constraints of a flight plan of an aircraft comprises the following steps:
A step of identifying (05) a current flight phase of the aircraft, the flight phase can be one of the following phases: CLIMB, CRUISE, DESCENT and APPROACH,
A step of determining a speed profile of CAS (Corrected Air Speed) type 10. The speed profile establishes a behavior of the aircraft with respect to a speed setpoint, the speed setpoint being a function of the current flight phase. The speed profile then represents a target speed to be observed by the aircraft at any point of the flight plan as a function of speed constraints present during the flight phases.
A step of determining a Mach speed profile 20. The Mach speed profile establishes a behavior of the aircraft with respect to a Mach setpoint, the Mach setpoint being a speed setpoint transcribed into an equivalent Mach number, the Mach setpoint therefore being also a function of the current flight phase. Thus, the Mach speed profile defines the Mach target to be reached by the aircraft at any point of the flight plan as a function of the speed constraints present during the flight phases.
A step of determining a Cross-Over altitude 50. The Cross-Over altitude is the altitude of transition from an automatic control of the aircraft according to the CAS speed profile to an automatic control according to the Mach speed profile of the speed profile. In other words, the Cross-Over altitude is the optimized altitude of transition between the CAS speed profile and the Mach speed profile,
A step of determining 30 an end-of-applicability criterion of the speed profile and of the Mach speed profile.

When the speed profile, including the Mach speed profile, the Cross-Over altitude and the end-of-applicability criterion are determined for the current flight phase, the management method 1 identifies the next flight phase in the flight plan and reiterates the steps cited previously, namely the steps of determining a speed profile 10, of determining a Mach speed profile 20, of determining a Cross-Over altitude 50 and of determining 30 an end-of-applicability criterion for the next flight phase until all the flight plan of the aircraft has been completed, that is to say until the aircraft has landed.

More specifically, the profile of a flight phase of an airplane conventionally comprises two portions, a first portion in which the automatic control setpoint is a CAS speed and a second portion, from a certain so-called Cross-Over (or XOVER) altitude, for which the speed setpoint is a Mach. Thus, the CAS speed setpoint is determined in the construction of the speed profile in order to control the behavior and the speed of the aircraft during the first portion in which the automatic control setpoint is linked to a CAS speed. The Mach setpoint is determined in the construction of the Mach speed profile in order to control the behavior of the aircraft during the second portion of the flight phase in which the automatic control setpoint is linked to a Mach.

Indeed, from some altitudes, it becomes necessary to automatically control the speed of the aircraft no longer as a function of an air speed (CAS) but based on a Mach number, representing the speed of the aircraft with respect to the local speed of sound, which varies as a function of temperature. A Mach number then represents a limit speed at higher altitudes because of the speed of sound and the possible shock waves which are associated therewith and which can become an aerodynamic limit to the aircraft. Now, this Cross-Over altitude represents a conversion altitude which makes it possible to switch over between an automatic control of the CAS speed of the aircraft via a speed and an automatic control of the speed of the aircraft via a Mach number is called Cross-Over altitude XOVER.

Consequently, the CAS speed profile and the Mach speed profile represent a pair of speed profiles which are applied in succession to the current flight phase in response to a speed setpoint or a Mach setpoint, representing the speed setpoint transcribed into a Mach number, these speed and Mach setpoints being functions of the current flight phase. Indeed, as an indicative example, for a climbing phase CLIMB, a CAS speed profile is determined and is applied conventionally according to a first portion of the climbing phase of the aircraft until the appropriate altitude has been reached for switchover to a Mach mode automatic control or Cross-Over altitude, from which the speed setpoint is a Mach setpoint and therefore for which a Mach speed profile is determined and is applied for a second portion of the climbing phase from the Cross-Over altitude.

Conversely, in a descent phase DESCENT, a CAS speed profile and a Mach speed profile are determined and it is the Mach speed profile which is applied to a first portion of the descent phase until the appropriate altitude for switchover to a Mach mode automatic control or Cross-Over altitude has been reached, from which the speed setpoint is a CAS speed setpoint and therefore for which a CAS speed profile is applied for a second portion of the descent phase from the Cross-Over altitude.

The Cross-Over altitude XOVER therefore represents the altitude at which a specific speed becomes a specific Mach number, or vice versa.

The Cross-Over altitude therefore represents the optimized or appropriate altitude of transition between a CAS speed profile and a Mach speed profile.

It may also be observed, as a function of external parameters or parameters of the aircraft, that the Cross-Over altitude is not reached and that the current flight phase is only completed through a CAS speed profile for example. This is notably the case for a flight at low altitude or a short-haul flight.

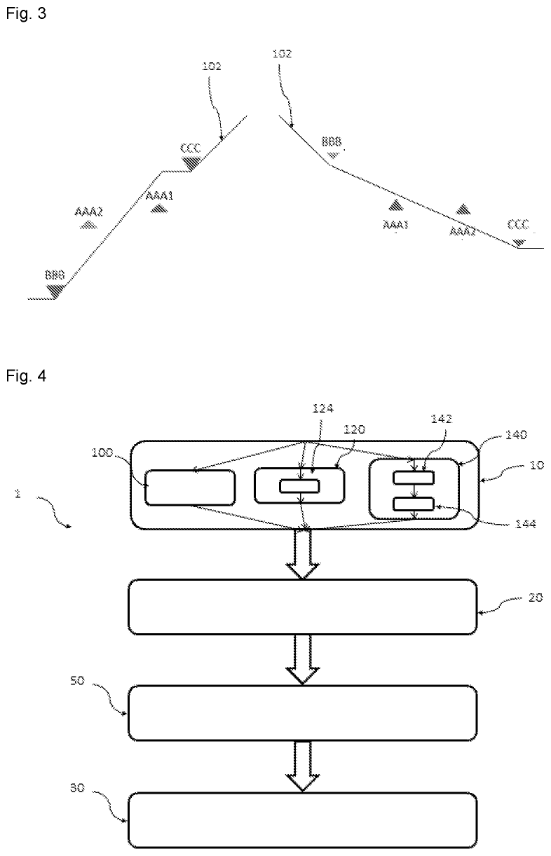

The step of determining the speed profile 10 can comprise, as represented in FIG. 2, a step of constructing a first CAS speed profile 100. The speed setpoint according to the first speed profile is then constructed on the basis of the performance levels of the aircraft. More specifically, the speed setpoint according to the first speed profile is based on the assumption that the speed constraints are compatible with the performance levels of the aircraft. This first speed profile is then constructed without taking into account the presence of the speed constraints of AT OR ABOVE type, or AT constraints considered for their “minimum speed” aspect and therefore without taking into consideration the presence of these minimum speeds that the aircraft must reach. Consequently, the aircraft travels the flight phase according to the first speed profile which considers only the minimum AT OR BELOW speed constraints which takes the position that these constraints alone are sufficient, the other AT OR ABOVE or AT constraints being automatically observed because of the characteristics and the performance levels of the aircraft. Once the first speed profile is constructed, as is represented in FIG. 3, a state of the locations of these constraints is established. Thus, the aircraft, in following the first speed profile 102, observes only AT OR BELOW constraints BBB and CCC and deliberately disregards AT OR ABOVE constraints AAA1 and AAA2, which are deemed to be generated in accordance with the performance levels of the aircraft. Consequently, the AT OR ABOVE speed constraint AAA1, which represents a minimum speed lower than the calculated first speed profile 102, at the level of the constraint AAA1, is then observed. Conversely, the AT OR ABOVE speed constraint AAA2, which is higher than the first speed profile 102 at the transition from the AT OR ABOVE speed constraint AAA2 of the aircraft according to the first speed profile 102, is not then observed. This information on non-observance of a speed constraint can then be referred to the operator so as to warn of this irregularity in maintaining the speeds of the flight phase of the aircraft.

This irregularity is then explained by an ill-suited energy ratio between kinetic energy representative of the horizontal acceleration and therefore of the “horizontal” speed of the aircraft and potential energy representative of the vertical acceleration and therefore of the “vertical” speed of the aircraft.

Consequently, the step of determining the speed profile 10 can comprise a step of constructing a second CAS speed profile 120, represented in FIG. 4, by adapting the distribution of the energy between kinetic and potential. The speed setpoint according to the second speed profile then allows the aircraft to observe all of the AT and AT or ABOVE and AT or BELOW speed constraints in the flight phase by modifying the ratio between kinetic energy, namely horizontal speed, and potential energy, namely vertical speed, by increasing the kinetic energy to the detriment of the potential energy. Thus, the aircraft, by observing the second speed profile, is then able to gain or lose altitude with a lower vertical gradient. The determining of the modified ratio and the distribution between kinetic energy or horizontal speed and potential energy or vertical speed can be performed in a modified ratio calculation step 124, represented in FIG. 4, by different known methods such as dichotomy, brute force calculation or through a digital estimator. Thus, the second speed profile 120 makes it possible to obtain a flight setpoint that observes all of the speed constraints, whether minimum or maximum.

Furthermore, the step of determining the speed profile can comprise a step of constructing a third CAS speed profile 140. The speed setpoint according to the third speed profile is then constructed in the knowledge of a predefined target speed of the aircraft and a predefined speed constraint, the predefined speed constraint being an AT or AT or ABOVE speed constraint. More specifically, the third speed profile consists in targeting an optimal speed called economic speed of the flight phase ECON. Consequently, the speed constraints lower than this economic speed ECON are not considered in the construction of the third speed profile. In addition, only the strongest or greatest of the AT or AT or ABOVE speed constraints is studied, that is to say that only the speed constraint imposed on the aircraft describing the highest speed to be reached for the aircraft is considered. If this strongest speed constraint is lower than the economic speed ECON of the flight phase, then the third speed profile considers only the economic speed ECON of the flight phase.

If the strongest speed constraint is higher than the targeted economic speed ECON of the flight phase then the ratio between the kinetic energy and the potential energy of the aircraft is adapted so as to observe this stronger constraint. If the original ratio of the aircraft between horizontal speed and vertical speed makes it possible to satisfy the greatest speed constraint, then the latter is taken into consideration for the construction of the third speed profile. The step of constructing the third speed profile 140 can thus comprise a step of comparison 142 between the economic speed of the flight phase and the strongest speed constraint of the flight phase making it possible to assess the taking into account of this greater speed constraint. The step of constructing the third speed profile 140 can also comprise a step of calculation 144 of the ratio between kinetic energy or horizontal speed and potential energy or vertical speed of the aircraft making it possible to satisfy the greatest speed constraint if the greatest speed constraint is higher than the economic speed ECON of the aircraft in the flight phase.

In the case where there is no compatible ratio that makes it possible to observe the greatest speed constraint while guaranteeing good performance levels of the aircraft, that is to say without degrading the aircraft itself, the step of constructing the third speed profile 140, through the ratio calculation step 144, makes it possible to calculate a ratio that makes it possible to “approximate” as far as possible the strongest constraint while observing the limit flight envelope.

The step of determining the Mach speed profile 20 makes it possible to provide Mach setpoints in accordance with the speed setpoint previously assigned to the aircraft, namely the first, second or third speed setpoint. The determination step 50 makes it possible, for its part, to determine, as a function of the speed setpoint established in the step of determining the speed profile 10 and the Mach setpoint established in the step of determining the Mach speed profile 20 for the aircraft, the Cross-Over altitude XOVER between the determined speed setpoint, namely the first, second or third speed setpoint, and the Mach setpoint determined in the step of determining the Mach speed profile 20.

Furthermore, the first, second and third CAS speed profiles can be applied according to a so-called BACKWARD calculation method.

The BACKWARD method makes it possible, for the DESCENT phase, to calculate a backward speed profile, in which the speed constraints follow one another beginning from the approach speed of the aircraft and accelerating backward from constraints to constraints to the start-of-descent speed. Generally, the BACKWARD method presents the calculation of a reference speed profile that the aircraft must follow. The aircraft follows, through the flight management system, a speed profile calculated according to the FORWARD method, in real-time, making it possible for the aircraft, in the DESCENT or APPROACH phase for example, to take into consideration factors external to the aircraft such as the real climatic conditions. The flight management method 1 then allows the flight management system to take into consideration the speed indicators and the levels or speed constraints generated by the reference, namely the BACKWARD method, and to automatically control the flight pan generated by the FORWARD method on these speed indicators and on the levels or speed constraints for the flight phase. This automatic control is particularly advantageous in DESCENT or APPROACH phase in order to allow the aircraft to target aircraft deceleration points, which can be interpreted as speed indicators to be observed for the aircraft in the flight phase, between each speed constraint so as to shorten the DESCENT or APPROACH phase.

Thus, the first, second or third speed profile is constructed so as to represent a backward speed profile. More specifically, the management method 1 allows the construction of the first, second or third speed profile backward by taking into consideration all of the speed constraints of the flight phase, namely the AT, AT OR ABOVE and AT OR BELOW constraints, and no longer only the AT OR BELOW speed constraints, and particularly those necessary to the speed setpoint such as, for example, the strongest speed constraint for the third speed profile.

Thus, since the flight management system FMS operates generally according to a FORWARD calculation method different from the BACKWARD method, the management method 1 also allows the automatic control of this method favoring the BACKWARD method according to the invention.

In addition, as stated previously, the aircraft can, according to certain particular cases, reach altitudes where the automatic control of the aircraft must be done via a Mach setpoint and not via a speed setpoint risking harm to the integrity of the aircraft. Consequently, the management method 1 can construct different strategies that make it possible to automatically control the airplane according to a CAS or Mach speed setpoint in a given zone of applicability.

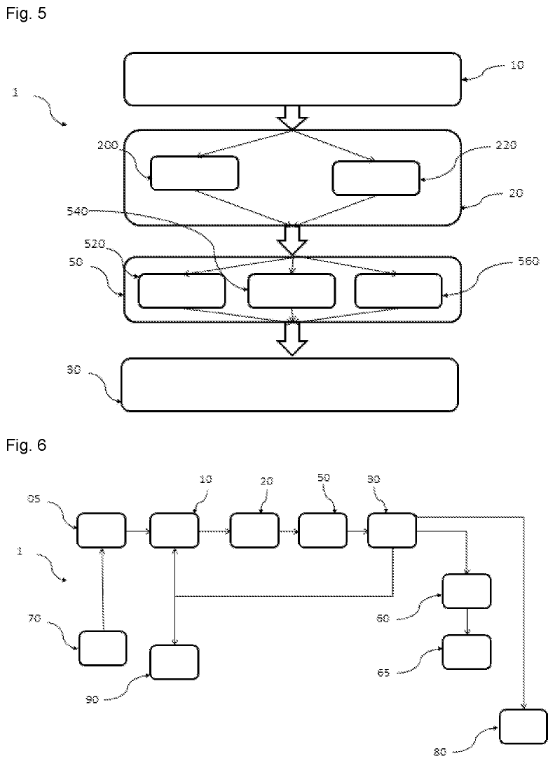

Thus, the step of determining the Mach speed profile 20 comprises, as represented in FIG. 5, a step of constructing a first Mach speed profile 200. The Mach setpoint according to the first Mach speed profile is determined as a function of a predefined Mach. More specifically, this construction of the first Mach speed profile 200 relies on the characteristics and the performance levels of the aircraft since the Mach setpoint according to the first speed profile requires the observance of an economic Mach or MACH ECON representing the economic flight Mach of the aircraft. Indeed, the economic Mach corresponds to the speed at which, in the environment where the Mach setpoint prevails, the aircraft exhibits performance levels that are optimized by taking into consideration different performance parameters such as the speed of the aircraft or even the power deployed compared to cost parameters such as the consumption of the aircraft. The constructed Mach setpoint will then observe the economic Mach MACH ECON until the end-of-applicability criterion determined previously in the determination step 30. This first Mach speed profile 200 then allows the aircraft to observe, initially, the speed setpoint defined during the step 10 until the Cross-Over altitude XOVER and then to observe, as the only setpoint, the economic Mach MACH ECON of the aircraft.

It should be noted that the first Mach speed profile can lead to the non-observance of speed constraints after reaching the Cross-Over altitude XOVER allowing the transition from a speed setpoint to a Mach setpoint. In fact, a constant Mach does not generally mean having a constant CAS speed because of the change of altitude and therefore of temperature and of pressure. Nevertheless, this non-observance can be announced to the operator of the aircraft who can deem this irregularity to be acceptable for the operation of the aircraft.

Furthermore, the step of determining the Mach strategy 20 can comprise a step of constructing a second Mach speed profile 220 allowing the aircraft to observe all of the AT and AT or ABOVE speed constraints in the given zone of applicability. The Mach setpoint according to the second Mach speed profile is then constructed in the knowledge of the strongest speed constraint. More specifically, the second Mach speed profile aims to allow the aircraft to observe all of the speed constraints in the given zone of applicability of the aircraft, in a way similar to the construction of the second speed profile 120. Consequently, the Mach setpoint corresponds to the strongest constraint of the flight phase previously determined in the CAS speed setpoint and automatically controls the aircraft according to this strongest CAS speed constraint converted into a Mach number. It should be noted that, in the case where the aircraft is automatically controlled, on the current flight phase, according to the CAS speed setpoint of the third speed profile, the Mach setpoint according to the second Mach speed profile can then be a conversion of this CAS speed setpoint into a Mach number. In addition, as stated previously, once the Cross-Over altitude XOVER is exceeded, it is no longer possible to envisage controlling the behavior of the aircraft through a CAS speed setpoint. The Mach speed profile takes precedence over the CAS speed profile, no longer imposing an automatic control of the CAS speed but an automatic control of the Mach of the aircraft. Now, maintaining a constant Mach after the Cross-Over altitude XOVER, by gaining altitude, leads to a lowering of the CAS speed of the aircraft.

Thus, the step of determining the Cross-Over altitude 50 XOVER allowing the switchover from the CAS speed setpoint to the Mach setpoint can comprise, as represented in FIG. 5, a step of calculation of a first Cross-Over altitude 520. The first Cross-Over altitude XOVER1 is then calculated as a function of a first CAS speed constraint, which can be, by way of preferential example, the strongest AT or AT or ABOVE speed constraint, the economic speed ECON of the aircraft and the economic Mach of the aircraft. As an indicative example, the first Cross-Over altitude can be calculated according to the following formula:

$$XOVER 1 ∈ [ max ( {CAS}_{max} ; CAS ECON ) ; MACH ECON ]$$

in which XOVER1 represents the first Cross-Over altitude, CASₘₐₓ represents the strongest speed constraint, CAS ECON represents the economic speed ECON of the aircraft and MACH ECON represents the economic Mach of the aircraft.

The step of determining the Cross-Over altitude 50 can also comprise a step of calculating a second, or chosen, Cross-Over altitude 540 allowing the switchover between CAS speed setpoint and Mach setpoint. The second Cross-Over altitude XOVER2 is then the chosen altitude allowing the aircraft to observe the CAS speed setpoint of the speed profile before the switchover to a Mach setpoint.

As an indicative example, the second Cross-Over altitude XOVER2can be calculated according to the following formula:

$$XOVER 2 ∈ [ max ( {CAS}_{max} ; CAS ECON ) ; {MACH}_{2} ]$$

In which XOVER2 represents the chosen Cross-Over altitude and MACH₂ represents the second Mach speed profile.

Finally, the step of determining the Cross-Over altitude 50 XOVER can comprise a step of calculation of a third Cross-Over altitude 560 allowing the switchover between CAS speed setpoint and Mach setpoint. The third Cross-Over altitude XOVER3 then lies between the altitude of a predefined second AT or AT or ABOVE constraint, which can be, by way of preferential example, the strongest AT or AT or ABOVE speed constraint, or the altitude of the economic speed ECON if the economic speed ECON is higher than the strongest AT or AT or ABOVE speed constraint, and the altitude corresponding to the highest speed between the Mach equivalent to the second AT or AT or ABOVE CAS speed constraint, namely, by way of preferential example, the strongest speed constraint, at an imposed flight level CRZ and the economic Mach ECON MACH.

As an indicative example, the third Cross-Over altitude XOVER3 can be calculated according to the following formula:

$$XOVER 3 ∈ [ max ( {CAS}_{max} ; CAS ECON ) ; {MACH}_{{2}_{CRZ}} ]$$

in which MACH₂_{_{CRZ}} represents the second Mach speed profile at the imposed flight level CRZ.

The determination step 30, making it possible to determine a first end-of-applicability criterion 320, that makes it possible to end the CAS speed setpoint and the Mach speed profile, can correspond to an end of the flight phase, such as, for example, the end of a CLIMB phase or a CRUISE phase. As a variant, the determination step 30 makes it possible to determine a second end-of-applicability criterion 340 corresponding to having reached a predefined altitude such as the Cross-Over altitude XOVER. Indeed, it is perfectly possible to envisage a flight phase, for example of CLIMB type, in which the Cross-Over altitude XOVER imposing the transition to a Mach setpoint to allow the automatic control of the aircraft coincides with the maximum altitude reached by the aircraft in a CLIMB phase. In addition, the determination step 30 makes it possible, in an additional variant, to determine a third criterion 360, representing a point of the flight plan. As an indicative example, the last point of the flight plan reflecting the end of a departure procedure in CLIMB phase, can be envisaged as third end-of-applicability criterion making it possible to end the CAS speed setpoint and the Mach speed profile.

The third end-of-applicability criterion offers the advantage of being able to maintain the CAS speed setpoint and/or the Mach setpoint beyond the flight phase. Thus, as an indicative example, the third end-of-applicability criterion makes it possible to maintain the strongest speed constraint beyond the CLIMB flight phase and to have it applied also to the next CRUISE phase. This particular case can occur when the cruising level of the aircraft is low, in the case for example of a relatively short flight to a nearby airport, or else when flight envelope restrictions limit the cruising altitude.

The end-of-applicability criterion advantageously makes it possible to end the speed profile currently being applied in order to allow the transition to a new speed setpoint linked directly to the next flight phase, the current speed profile being the CAS speed profile or the Mach speed profile.

The method 1 for managing speed constraints can also comprise a step of elimination of a speed constraint 70. Indeed, an AT OR ABOVE speed constraint is applicable from the point with which it is associated and, likewise, an AT constraint becomes a minimum speed from the point with which it is associated. Consequently, once the constraint is implemented, it is no longer possible to easily eliminate it since the associated point has just been sequenced and therefore has disappeared from the displayed flight plan. The elimination step 70 makes it possible to eliminate this speed constraint despite the absence of the point with which it is associated. Moreover, this step of elimination of a speed constraint 70 is independent of the other steps of the management method 1 and leads automatically to a reinitialization of the management method 1 and of the step of determining a speed profile 10. Thus, the step of eliminating a speed constraint 70 can be initialized following the step of determining the end-of-applicability criterion or precede the step of identifying 05 the current flight phase, allowing an operator the freedom to decide on the impact of any speed constraint on the flight plan of the aircraft.

Similarly, the method for managing speed constraints can comprise an additional step of adjusting the speed 80 of the aircraft with respect to a speed constraint of the next flight phase. This is notably the case upon the transition from a CRUISE phase to a DESCENT phase of the aircraft with the appearance of a first speed constraint in the DESCENT phase that is greater, even clearly greater, than the speed of the aircraft in the CRUISE phase. Consequently, in order not to impose a modification of the speed that is too great between the end-of-applicability zone of the flight phase, namely the CRUISE phase, and the first speed constraint of the next flight phase, namely the DESCENT phase, the management method 1 can allow the aircraft, via the step of adjusting the speed 80, to adjust its speed with respect to this first speed constraint of the next phase, or DESCENT phase, by forcing the next highest speed constraint to be maintained even once the end-of-applicability condition has been reached for the current flight phase, that is to say the CRUISE phase. This situation can occur, for example, in the case of cruising at low altitude. Consequently, when the aircraft begins the next flight phase, namely the DESCENT phase, the aircraft maintains a high speed in accordance with the higher speed constraint of the preceding flight phase, the CRUISE phase, in order to limit the speed gradient between the two flight phases and ensure an appropriate transition from the CRUISE phase to the DESCENT phase.

Furthermore, the method 1 for managing speed constraints comprises a speed-maintaining step 60 during the current flight phase. More specifically, the maintaining step 60 imposes a maintaining speed or speed imposed on the aircraft until an event bringing about the cancellation of this maintaining of the speed of the aircraft. As a nonlimiting example, the maintaining step 60 can impose a maintaining speed on the aircraft until a speed constraint or until an indicative speed. Indeed, when the flight phase is a CRUISE phase and the aircraft is close to a transition to DESCENT phase, synonymous with descent of the aircraft to the airport, the maintaining step 60 makes it possible to maintain the speed of the aircraft until a speed constraint of the DESCENT phase. Thus, the maintaining step 60 makes it possible to manage this CRUISE-DESCENT transition by eliminating any deceleration and/or acceleration deemed pointless by the flight operator, increasing the complexity of the flight phase and in particular the CRUISE-DESCENT transition and considerably increasing the fuel consumption of the aircraft during the flight phase. Furthermore, the maintaining step 60 can also maintain a speed imposed on the aircraft directly in DESCENT phase for example until an event cancelling this maintaining. As an indicative example, the maintaining step 60 makes it possible to efficiently manage the transition from a current flight phase to the next flight phase, such as, for example, the CRUISE-DESCENT transition but also the CLIMB-CRUISE transition.

The management method 1 also comprises a step of monitoring 65 the speed constraints when the aircraft is travelling a DESCENT phase or an APPROACH phase. More specifically, the monitoring step 65 makes it possible to memorize the AT OR ABOVE speed constraints and the speed indicators generated by the BACKWARD method in order to allow the observance of the speed constraints and of the speed indicators by the FORWARD method of the flight management system of the aircraft. It thus becomes possible to automatically control and align the FORWARD method of the flight management system scheduling the flight plan with respect to the reference of the BACKWARD method and therefore keep the time and consumption predictions of the aircraft for example more stable, for example.

In addition, the management method 1 can comprise a step of displaying 90 speed constraints during the flight phase. More specifically, this display step 90 makes it possible to memorize and display the speed constraints of the aircraft, such as, for example, the highest AT or AT OR ABOVE speed constraint potentially greater than the economic speed. This display is notably relevant in the case cited previously of presence of a first AT or AT OR ABOVE speed constraint in a DESCENT phase while the aircraft is in CRUISE phase. Thus, the display of this first constraint gives the operator an early warning.

The invention also provides a computer program product comprising code instructions making it possible to perform the steps of the management method 1 when said program is run on a computer.

The embodiments of the invention can be implemented by various means, for example by hardware, software, or a combination thereof.

Generally, the routines executed to implement the embodiments of the invention, whether they are implemented in the context of an operating system or of a specific application, of a component, of a program, of an object, of a module or of a sequence of instructions, or even of a subset thereof, can be designated herein as “computer program code” or simply “program code”. The program code typically comprises computer-readable instructions which reside at various moments in various memory and storage devices in a computer, and which, when they are read and executed by one or more processors in a computer, cause the computer to perform the operations necessary to execute the operations and/or the elements specific to the varied aspects of the embodiments of the invention. The computer-readable program instructions for performing the operations of the embodiments of the invention can be, for example, the assembly language, or even a source code or an object code written in combination with one or more programming languages.

The method for managing speed constraints according to the invention thus offers the advantage of making it possible to determine automatically, as a function of the speed constraints taken into account, namely for example the constraints linked to the integrity of the aircraft directly in the case of the first CAS speed profile, or even the speed constraints applicable during the flight phase travelled in the case of the second CAS speed profile, a CAS speed profile and Mach speed profile pairing that is applicable to the aircraft on the flight phase being travelled. This automatic determination is done advantageously without manual action on the part of the flight operators, thus making it possible to free them of an implementation that is tedious and costly in time and in energy.

Furthermore, the fact of being able to segment each flight phase and therefore being able to apply a speed or Mach setpoint according to each flight phase also offers the advantage of facilitating the understanding and the choices of the flight operators who then know only of the speed constraints applied over the current flight phase, thus limiting the “pollution” generated by the other speed constraints that apply only for other specific situations during the flight.

The invention therefore makes it possible to greatly reduce the workload of the pilot during the flight phases in which the speed constraints can occur.

Furthermore, the invention makes it possible, through the automation of the management of these speed constraints and the construction of a speed profile, to inform the pilot on the “success” or “failure” status of these speed constraints.

The invention also guarantees to the pilot that, in “managed” mode, the aircraft will automatically observe any restrictive speed constraint.

Finally, the invention makes it possible to see when a speed constraint is no longer applied, whether because it has been sequenced according to one of the chosen criteria or else because it has been eliminated by the crew.

1. A method for managing speed constraints of a flight plan of an aircraft, the method comprising the following steps:
identifying a current flight phase from among Climb, Cruise, Descent and Approach,
determining a CAS speed profile, the speed profile establishing a behavior of the aircraft with respect to a speed setpoint, the speed setpoint being a function of the current flight phase,
determining a Mach speed profile, the Mach speed profile establishing a behavior of the aircraft with respect to a Mach setpoint, the Mach setpoint being a speed setpoint transcribed into an equivalent Mach number, the Mach setpoint being a function of the current flight phase,
determining a Cross-Over altitude, the Cross-Over altitude being an altitude of transition from an automatic control of the aircraft according to the CAS speed profile to an automatic control according to the Mach speed profile, the Cross-Over altitude being the optimized altitude of transition between the CAS speed profile and the Mach speed profile,
determining an end-of-applicability criterion of the current speed profile, the current speed profile being the CAS speed profile or the Mach speed profile.

2. The method for managing speed constraints as claimed in claim 1, wherein the step of determining the CAS speed profile comprises a step of constructing a first CAS speed profile, the speed setpoint according to the first CAS speed profile being constructed on the basis of aircraft performance levels.

3. The method for managing speed constraints as claimed in claim 1, wherein the step of determining the CAS speed profile comprises a step of constructing a second CAS speed profile, the speed profile according to the second speed profile allowing the aircraft to observe all of the AT and AT or ABOVE speed constraints in the flight phase.

4. The method for managing speed constraints as claimed in claim 1, wherein the step of determining the speed profile comprises a step of constructing a third CAS speed profile, the speed setpoint according to the third speed profile being constructed in the knowledge of a predefined target speed of the aircraft and a predefined speed constraint, the predefined speed constraint being an AT or AT or ABOVE speed constraint.

5. The method for managing speed constraints as claimed in claim 1, wherein the step of determining the Mach speed profile comprises a step of constructing a first Mach speed profile, the Mach setpoint according to the first Mach speed profile being determined as a function of a predefined Mach.

6. The method for managing speed constraints as claimed in claim 1, wherein the step of determining the Mach speed profile comprises a step of constructing a second Mach speed profile, the Mach setpoint according to the second Mach speed profile allowing the aircraft to observe all of the AT and AT or ABOVE speed constraints in the flight phase.

7. The method for managing speed constraints as claimed in claim 1, wherein the step of determining a Cross-Over altitude comprises a step of calculating a first Cross-Over altitude, the first Cross-Over altitude being calculated as a function of a predefined first AT or AT or ABOVE CAS speed constraint, a previously defined CAS speed and a previously defined Mach.

8. The method for managing speed constraints as claimed in claim 1, wherein the step of determining a Cross-Over altitude comprises a step of calculating a second Cross-Over altitude, the second Cross-Over altitude being a function of a second predefined AT or AT or ABOVE CAS speed constraint, of an imposed flight level and of a previously defined Mach.

9. The method for managing speed constraints as claimed in claim 1, wherein the step of determining a Cross-Over altitude comprises a step of calculating a chosen Cross-Over altitude, the chosen Cross-Over altitude being the altitude that allows the aircraft to observe the CAS speed setpoint.

10. The method for managing speed constraints as claimed in claim 1, wherein the end-of-applicability criterion is an end of the flight phase or having reached a predefined altitude.

11. The method for managing speed constraints as claimed in claim 1, comprising a step of elimination of a speed constraint following the step of determining the end-of-applicability criterion.

12. The method for managing speed constraints as claimed in claim 1, comprising a step of maintaining an imposed speed of the flight phase.

13. The method for managing speed constraints as claimed in claim 1, comprising a step of monitoring the speed constraints.

14. The method for managing speed constraints as claimed in claim 1, comprising an additional step of adjusting the speed of the aircraft with respect to a first speed constraint of the next flight phase.

15. The method for managing speed constraints as claimed in claim 1, comprising a step of displaying speed constraints during the flight phase.

16. A computer program product, said computer program comprising code instructions making it possible to perform the steps of the method as claimed in claim 1, when said program is run on a computer.
